(19) United States
(12) Patent Application Publication
(10) Pub. No.: US 2005/0206026 A1
(43) Pub. Date: Sep. 22, 2005

(54) Heated press for use in injecting insulating foam in a roof assembly

(75) Inventors: Richard Paul Miller, Worth, MO (US); Ronald Orion Stooksbury, Albany, MO (US); Alfred Leon Dillivan, Albany, MO (US); Harold G. Owens, Albany, MO (US); Robert E. Sutton, Albany, MO (US); Michael Dean Burton, Albany, MO (US)

Correspondence Address: MCNEES, WALLACE & NURICK LLC, 100 PINE STREET, P.O. BOX 1166, HARRISBURG, PA, 17108-1166, US

(73) Assignee: YORK INTERNATIONAL CORPORATION, YORK, PA (US)

(21) Appl. No.: 10/805,688

(22) Filed: Mar. 22, 2004

(51) Int. Cl. B29C 44/18

(52) U.S. Cl. 264/45.1; 425/110

(57) ABSTRACT

A press includes an upper platen and a heated lower platen that are selectably movable toward and away from each other. A vessel inserted between an upper platen and a heated lower platen is conformally but nondeformingly secured therebetween so that vessel surfaces in conformal contact with the upper platen and the lower platen remain substantially undeformed while the vessel is filled with a pressurized insulating foam material. A portion of the vessel that is heated to at least a predetermined temperature by the heated lower platen promotes uniform expansion and curing of the injected foam within the vessel, and additionally promotes bonding between the injected foam and the heated portion of the vessel.

### FIELD OF THE INVENTION

The present invention relates generally to a press for use with vessels, and more particularly to a heated press for use in injecting insulating material in vessels or assemblies.

### BACKGROUND OF THE INVENTION

It is desirable to use insulating material(s) with structures to reduce the energy costs associated with maintaining temperature control within the structures. Examples of some structures using insulating materials include most enclosed, habitable structures and air handling units (AHUs) which are one of several components in cooling and heating systems used with such enclosed, habitable structures. AHUs house a number of components used in these cooling and heating systems to provide forced air for climate or temperature control in a particular structure. AHU components typically include motors, heating/cooling coils, and blowers as well as the required interface connections to effect such climate control. The AHU and the AHU components define interconnected modular frame members preferably spanned by insulated panels.

While insulating material can take many forms, such as rolls or small pieces of material that are installed or “blown” between adjacent joists of a structural frame, these materials are not typically suitable for installing inside closed structures or vessels, such as AHU insulated panels. However, foam insulating material, which is typically installed by pressurized injection techniques, may be used with closed structures.

Foam insulating material has several advantageous properties, including structural strength and rigidity while being of light weight construction. However, due to the elevated injection pressures associated with its installation, there may be a danger that the closed structure or vessel, due to the elevated pressure created inside the structure or vessel during the injection process, may rupture, or at least become deformed. Further, for the insulating material to expand to effectively fill the interior of the closed structure, not only must a proper amount of material be injected into the closed structure, but there must also be sufficient temperature control, which may affect the expansion and cure of the material. Temperature control includes not only the ambient temperature of the air surrounding the closed structure, but the temperature of the closed structure itself, which may not only affect the expansion and cure of the material, but the extent of bonding between the cured material and the inside surfaces of the closed structure. This bonding may significantly increase the strength of the closed structure.

Thus, there is a need for a press having platens configured to conformally receive a closed structure or vessel therein to provide structural support while the closed structure or vessel is being filled with injected, pressurized foam material to prevent the closed structure or vessel from deforming. There is a further need for a press having a heated platen for heating the closed structure or vessel to promote uniform expansion and curing of the insulating foam material inside of the closed structure or vessel to not only effectively fill the structure or vessel with insulating foam material, but to also promote bonding of the cured foam material to the inside surfaces of the closed structure.

### SUMMARY OF THE INVENTION

The present invention relates to a press comprising an upper platen and a heated lower platen that are selectably movable toward and away from each other. The upper and lower platens conformally but nondeformingly receive a vessel therebetween so that vessel surfaces are in conformal contact with the upper platen and the lower platen and remain substantially undeformed while the vessel is filled with a pressurized material. A portion of the vessel is heated to at least a predetermined temperature by the heated lower platen prior to filling the vessel with the pressurized material. As used herein, the terms vessel and closed container are interchangeable.

The present invention further relates to a method of filling a vessel with a pressurized material, the steps comprising: providing a press having an upper platen and a heated lower platen that are selectably movable toward and away from each other; securing the vessel conformally but nondeformingly between the upper platen and the heated lower platen so that a portion of the vessel is heated to at least a predetermined temperature by the heated lower platen; and filling the vessel with a pressurized material so that vessel surfaces which are in conformal contact with the upper platen and the lower platen remain substantially undeformed while the vessel is filled with a pressurized material.

Among the principal advantages of the present invention is the provision of a heated press having an upper and a lower platen for conformally but nondeformably securing a vessel therebetween to provide structural support while the closed structure or vessel is being filled with injected, pressurized insulating material to prevent the vessel from deforming.

Another advantage of the present invention is the provision of a press having a heated platen in contact with a vessel for promoting uniform expansion and curing of the insulating material inside of the vessel to effectively fill the vessel with insulating material for enhancing insulative properties of the vessel.

A further advantage of the present invention is the provision of a press having a heated platen in contact with a vessel for promoting uniform expansion and curing of the insulating material inside of the vessel, and also promoting bonding of the cured insulating material to the inside surfaces of the vessel to enhance structural properties of the vessel.

A still further advantage of the present invention is the provision of an adjustable upper platen for receiving vessels having non-parallel surfaces.

Yet another advantage of the present invention is the provision of an adjustable upper platen configurable to receive angled surfaces of a vessel.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a perspective view of an AHU roof assembly for use with a press of the present invention.

FIG. 2 is an elevation view of the press of the present invention.

FIG. 3 is a bottom view of a heated platen of the press of the present invention.

FIG. 4 is an enlarged, partial elevation view of the heated platen taken along line 4-4 of FIG. 3 of the present invention.

FIG. 5 is a top view of a roof angle platen of the press of the present invention.

FIG. 6 is a perspective view of a base plate having roller transfer balls for use with the press of the present invention.

FIG. 7 is an enlarged, partial elevation view of a hinge connection between inner and outer flaps of the roof angle platen of the present invention.

FIG. 8 is an elevation view of a graduated indicator for use with the press of the present invention.

FIG. 9 is a partial, elevation view of the roof angle platen receiving a long roof assembly configuration in the press of the present invention.

FIG. 10 is a partial, elevation view of the roof angle platen receiving a short roof assembly configuration in the press of the present invention.

Wherever possible, the same reference numbers will be used throughout the drawings to refer to the same or like parts.

### DETAILED DESCRIPTION OF THE INVENTION

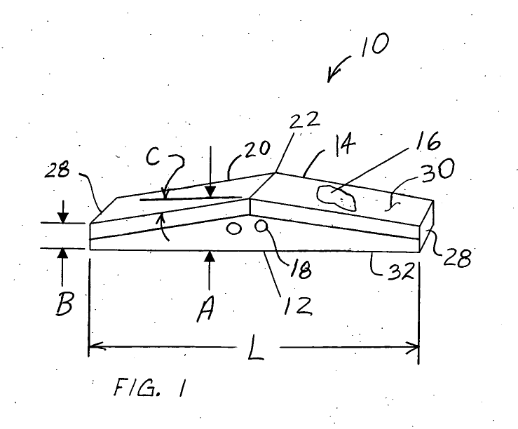

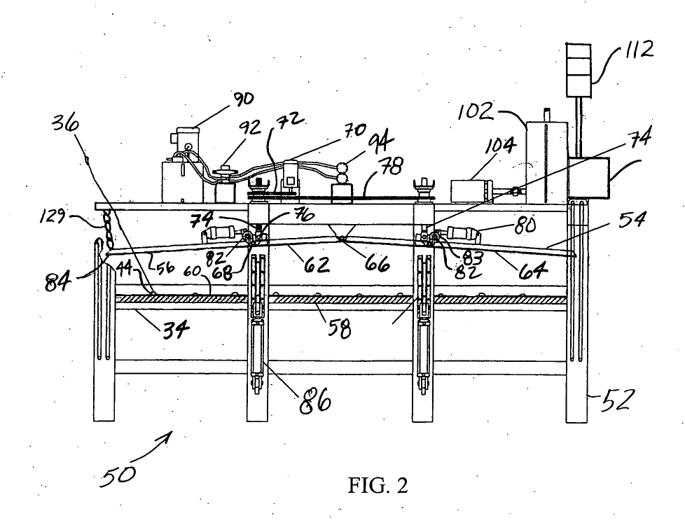

Referring to FIG. 1, a unitary, sloped roof assembly 10 for use with AHUs employs a heated press 50 (see FIG. 2) to nondeformably secure the roof assembly 10 while the roof assembly 10 is filled with insulating material, such as a pressurized foam material, and while the insulating material cures inside the roof assembly 10. The roof assembly 10 is supported atop an interconnected AHU structural frame and includes a fixture or housing 12 and an exterior skin 14 that collectively define a closed chamber 16. Exterior skin 14 includes two sloped halves 20 collectively defining an upper surface 30 having a peak 22 preferably at a mid span of exterior skin 14 and extending to opposed ends 28. Fixture 12 defines a preferably substantially planar lower surface 32, which provides a ceiling for AHU structures when the roof assembly 10 is installed atop the AHU structures. Importantly, the thickness of roof assembly 10 is non-uniform, ranging from a maximum thickness denoted by dimension “A” between peak 22 and lower surface 32, narrowing to a minimum roof thickness “B” between each end 28 and lower surface 32. Stated another way, upper surface 30 of roof assembly 10 is non-parallel to lower surface 32. An important purpose of the sloped upper surface 30 roof assembly 10 is to prevent water from accumulating on the upper surface 30 of roof assembly 10 that otherwise occurs when flat roof configurations are exposed to outside environmental conditions.

To enhance the insulating qualities of the roof assembly 10, pressurized foam material is preferably injected under pressure through each of two apertures 18. A dividing member (not shown) in the interior chamber 16 of roof assembly 10 divides the closed chamber 16 into two separate portions, which permits a more uniform application and cure of the insulating foam material. In addition, having two separate portions of the closed chamber 16 permits a substantially complete filling of the interior of closed chamber 16 with the insulating foam material. However, due to the elevated pressure levels created within closed chamber 16 during the injection process, there is a high likelihood of deformation, or possible rupture, of the upper surface 30 of exterior skin 14 and the lower surface 32 of fixture 12 of roof assembly 10 without conformal structural support provided by the press 50, since surfaces 30, 32 each defines a considerable surface area. Additionally, the press 50 has at least one set of platens that are heated to sufficiently heat a portion of the roof assembly 10, preferably lower surface 32, which promote bonding between the insulating foam material and the heated surfaces of the roof assembly 10, thereby increasing the structural strength of the roof assembly 10 as will be discussed in further detail below.

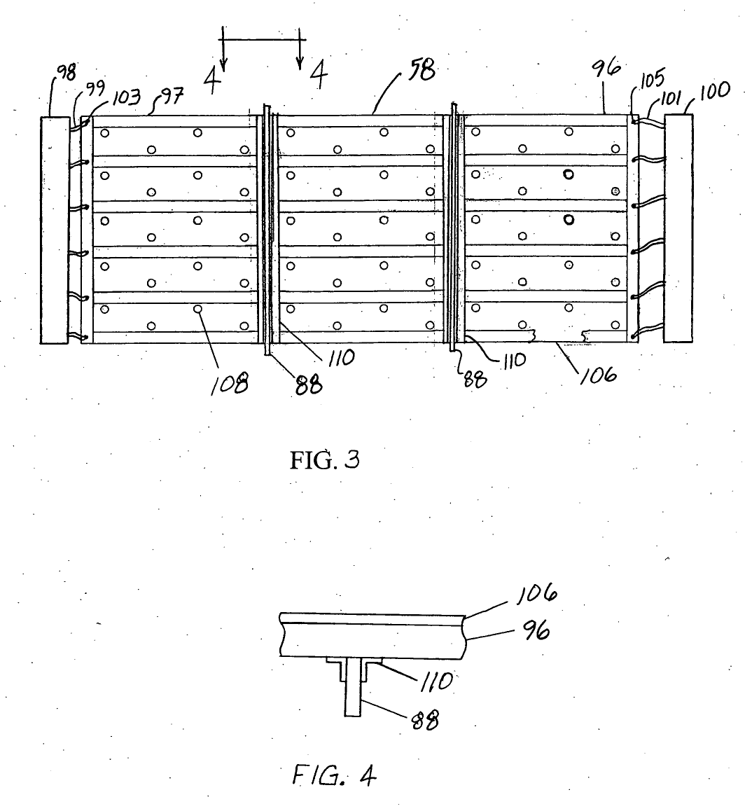

Referring to FIGS. 1-6, press 50 includes a structural frame 52 pivotably securing an adjustable upper platen 54 that defines an upper conformal surface 56 for conformally receiving the upper surface 30 of exterior skin 14 of roof assembly 10. Similarly, structural frame 52 slidably secures a lower platen 58 that defines a lower conformal surface 60 for conformally receiving the lower surface 32 of fixture 12 of roof assembly 10. The conformal fit between the conformal surfaces 56, 60 of platens 54, 58 and the respective surfaces 30, 32 of roof assembly 10 provide the necessary conformal structural support to prevent deformation and/or rupture of the roof assembly 10 while the roof assembly 10 is being filled with pressurized insulating foam material and while the foam material cures. For clarity, while there is conformal contact between respective platen 54, 58 and roof assembly surfaces 30, 32, the extent or magnitude of the pressure applied by the platens 54, 58 against the corresponding unpressurized roof assembly surfaces 30, 32, if any, is insufficient to deform the roof assembly surfaces 30, 32. However, the conformal surfaces 56, 60 of the platens 54, 58 are structurally rigid, and during the injection process are substantially immobile, to thereby apply reactive forces against the roof assembly surfaces 30, 32 attempting to flex or deform in response to the elevated pressure created within the closed chamber 16 of the roof assembly 10 during the injection process. Further, the lower platen 58 is heated by a heated fluid that is circulated through the lower platen 58 to maintain the temperature of the lower surface 32 of the roof assembly 10 to promote uniform expansion and curing of the injected foam material within the closed chamber 16 of the roof assembly 10 and to promote bonding between a portion of the heated roof assembly 10 and the insulating foam material.

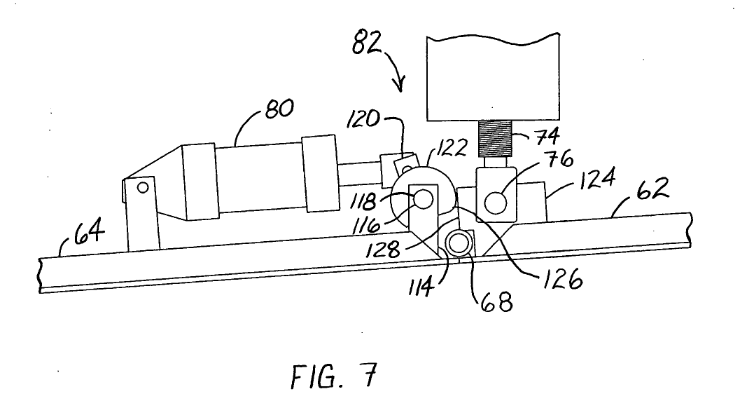

Upper platen 54 includes a pair of opposed inner flaps 62 and a pair of opposed outer flaps 64. Inner flaps 62 are rotatably secured to the structural frame 52 of press 50 by a hinge 66 along one end of inner flaps 62, and are each rotatably secured to outer flaps 64 by a hinge 68 along the opposite end of inner flap 62. To selectively control the angle between inner flaps 62 and lower platen 58, which is maintained in a substantially horizontal orientation, a chain 72 mutually meshing with a gear motor 70 and a lead screw 74 rotatably actuates lead screw 74 about its center axis along a threaded connection with structural frame 52 such that a pinned connection 76 at the end of lead screw 74 is raised or lowered, depending upon the rotational direction of gear motor 70. Since pinned connection 76 is also hingedly connected to a block 124 (see FIG. 7) that is secured to an end of inner flap 62 opposite hinge 66, raising or lowering pinned connection 76 likewise rotates inner flap 62 about hinge 66. By mutually meshing each lead screw 74 with a chain 78, the lead screws 74 may be simultaneously driven by rotational movement of gear motor 70.

Referring to FIGS. 2, 5 and 7, to selectively control the angular relationship between inner flap 62 and outer flap 64, an actuating device 80, such as a pneumatic cylinder receiving pressurized gas from a pressurized gas source (not shown), is provided. Actuating device 80 is hingedly connected to outer flap 64 at one end and to a mechanical linkage 82 at the other end. The mechanical linkage 82 is connected to outer flap 64 adjacent to hinge 68. Mechanical linkage 82 includes at least one pair of tabs 114 connected to outer flap 64 substantially adjacent to hinge 68. Each tab 114 has an aperture 116 for rotatably carrying a bar 118 that is inserted through apertures 116. An opposed pair of cams 122 are each fixedly secured to bar 118 such that cams 122 do not move or rotate with respect to bar 118. An arm 120 is also fixedly secured to bar 118 at one end and hingedly connected at the other end to actuator 80. By increasing the length of actuator 80, the bar 118 is urged into rotational movement about its center axis by virtue of its hinged connection with arm 120. The rotation of bar 118 likewise urges cams 122 into rotational movement about the center axis of bar 118. As further shown in FIG. 7, cam lobe 126, which is a region of increased radius of cam 122, is rotated to provide abutting contact with a surface 128 of a block 124 that is secured to inner flap 62. When cam 122 and block 124 are in abutting contact, outer flap 64 cannot rotate about hinge 68 in a direction away from lower platen 58.

Similarly, by decreasing the length of actuator 80, arm 120 urges bar 118 into rotational movement in the opposite direction along its center axis, which likewise urges cams 122 into rotational movement in the opposite direction about the center axis of bar 118. Cam 122 is rotated so that there is no longer abutting contact between cam lobe 126 and surface 128 of block 124. Upon removal of this abutting contact, outer flap 64 may be rotated about hinge 68 in a direction away from lower platen 58, such as by an additional actuator (not shown). Alternatively, for reasons to be discussed in additional detail below, there may be no need to raise or lower an end 84 of outer flap 64 opposite hinge 68, but merely to maintain the vertical position of end 84. A chain 129, or similar mechanical structure, is connected to frame structure 52 of press 50, and is connected to outer flap 64 substantially adjacent to end 84. Although each actuator 80 may be configured to actuate simultaneously, especially when the upper surfaces 30 of sloped halves 20 of roof assembly 10 are symmetrical, actuators 80 may also operate independently from each other.

Preferably, to receive roof assembly 10 in press 50, lower platen 58 is sufficiently lowered so that roof assembly 10 can be installed between upper platen 54 and lower platen 58 without having to raise end 84 of outer flap 64. Stated another way, if lower platen 58 is sufficiently lowered within press 50 so that the distance between lower platen 58 and end 84 of outer flap 64 is greater than thickness “A” (FIG. 1), it should be possible to install roof assembly 10 in press 50 without raising end 84 of outer flap 64. To install roof assembly 10 in press 50, peak 22 of roof assembly 10 and hinge 66 are vertically aligned and brought together by sufficiently raising lower platen 58. That is, lower platen 58 is raised until the distance between the upper conformal surface 56 along hinge 66 and the lower conformal surface 60 of lower platen 58 is substantially the same as thickness “A” (FIG. 1). In other words, the lower platen 58 is raised until peak 22 is brought into contact with hinge 66.

However, prior to raising lower platen 58, the upper conformal surface 56 of upper platen 54 and the upper surface 30 of roof assembly 10 must be properly oriented to each other to form a conformal contact. To achieve the conformal contact, each corresponding portion of upper conformal surface 56 of upper platen 54 and upper surface 30 of roof assembly 10 must be parallel. In other words, the angle defined by each sloped half 20 of roof assembly 10 must also be substantially defined by corresponding portions of upper conformal surface 56. Angle “C” (FIG. 1) may be calculated by taking the inverse tangent of the quantity defined by the difference between thicknesses “A” and “B” divided by one-half the distance “L” between opposed ends 28. This is stated symbolically in equation 1:
tan⁻¹((A−B)/(L/2))=C [1]

Preferably, for manufacturing convenience only, thicknesses “A” and “B” are the same for all roof assemblies. Thus for roof assemblies having substantially identical lengths “L,” the angles “C” are also substantially identical. However, press 50 can accommodate any number of roof assembly lengths “L” so long as the distance between opposed ends 28 of assembly 10 is less than or equal to the distance between opposed ends 84 of outer flaps 64 as. measured along a line parallel to lower surface 32 of roof assembly 10. Stated another way, press 50 can accommodate a roof assembly 10 having any length “L,” so long as substantially the entire upper surface 30 of roof assembly 10 can be conformally contacted by a corresponding portion of upper conformal surface 56 of upper platen 54.

By application of equation (1) above, it is appreciated that roof assembly 10 can have different lengths “L”, and likewise, have different slope angles “C.” Since it is preferred that each half of upper conformal surface 56 define substantially the same angle defined by its corresponding upper surface 30 of roof assembly 10 to achieve a conformal contact, it is also preferred that each corresponding surface 30, 56 define substantially the same angle. While this could eventually be achieved by trial and error, such as by making comparative angular measurements with a protractor placed upon surface 30 of roof assembly 10 and then manually attempting to replicate this angle for the corresponding conformal surface 56 of the upper platen 54, other more efficient approaches are available.

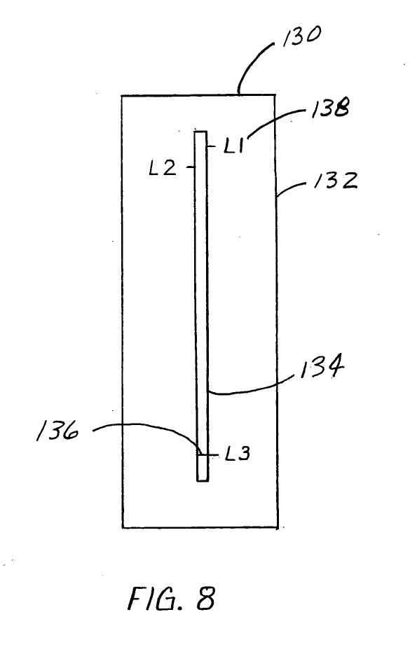

Referring to FIG. 8, one approach is to use a graduated angle indicator 130, which has an elongated enclosure 132 having a view window 134 for viewing an indicator line 136. The indicator line 136, which moves along view window 134, corresponds to a desired graduated indication 138. The position of indicator line 136 may be controlled by a mechanical link (not shown) such as threaded rod that is driven by gear motor 70, or electronic devices, such as sensors, that determine the position of indicator line 136 along viewing window 134. The electronic devices may be used in combination with either a mechanical or electrical device to provide the indicator line 136 for viewing. To provide enhanced viewing of indicator line 136, view window 134 may be comprised of a material, which can be configured to act as a magnifying lens. To further assist the press operator to determine the correct position of indicator line 136, when dimensions “A” and “B” are fixed graduated indications 138, defined as “L1,” “L2” and so on, corresponding to positions at which the angles of upper conformal surface 56 of upper platen 54 and upper surface 30 of roof assembly 10 are substantially equal. Thus, the operator merely needs to measure the length “L” of the roof assembly 10 as measured along its lower surface 32, although the part number of the roof assembly 10 may have this information. Stated another way, when indicator line 136 is aligned with a graduated indication 138, such as “L1,” upper conformal surface 56 of upper platen 54 will provide conformal contact with upper surface 30 of roof assembly 10 having a length of “L1.” To provide conformal contact between the upper platen and roof assembly surfaces, it is appreciated that the angles must be substantially the same, that is, within less than about one fourth of a degree.

It is appreciated that while angular control of upper platen 54 may be performed manually, it is also possible to automate such control, even when dimensions “A” and “B” of the roof assembly 10 are not fixed. Further, while the upper platen 54 is disclosed for use with roof assemblies 10 having symmetrical sloped halves 20, it is appreciated that each halves of upper platen 54 may be independently controlled to provide conformal contact with non-symmetrical halves of upper surface 30. It is further appreciated that while a non-symmetrical configuration may employ two graduated angle indicators 130, it may be possible to employ a single indicator 130, that toggles selectively the indicator line 136 readings between two different indicators or positions, especially if the indicator 130 is electronically controlled and displayed. However, it is understood that for non-symmetrical embodiments, graduated indications 138 would correspond to the fractional length of roof assembly 10 measured along lower surface 32 from end 28 to the divider, which is coincident with the intersection of a line perpendicular to lower surface 32 that passes through peak 22.

Although a preferred embodiment of the roof assembly 10 is symmetric about its peak 22, that is, each sloped roof half 20 is substantially identical, such symmetry is not required. The upper platen 54 may be configured so that each lead screw 74 operates independently of the other so that each pair of inner and outer flaps 62, 64 conformally contact its corresponding sloped roof half 20 even when upper surfaces 30 are nonplanar. Further, it is also possible to incorporate additional hinged joints to ends 84 of outer flaps 64 to incorporate additional outer flaps, if desired, to conformally receive sloped roofs having multiple portions or segments of varying slope.

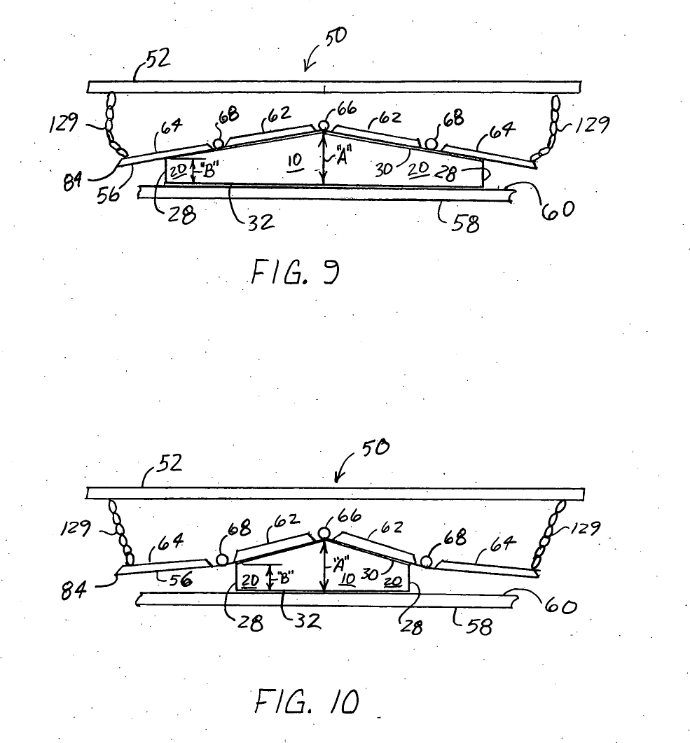

However, referring to FIG. 9, even when the roof assembly 10 is symmetric about its peak 22, and each portion of the upper surface 30 of the sloped halves 20 are coplanar, the length of roof assembly 10 must still be considered to achieve conformal contact of the upper and lower surfaces 30, 32 with the respective upper and lower platens 54, 58 of the press 50. That is, if the length of roof assembly 10 is greater than a predetermined length such that the ends 28 of the roof assembly 10 extend past the opposed pair of hinges 68 when the roof assembly 10 is positioned in the press 50, the upper conformal surface 56 of both the outer flaps 64 and the inner flaps 62 can be required to achieve conformal contact with the upper surface 30 of the roof assembly 10. When both the upper and the lower platens 54, 58 are required to achieve this conformal contact, a fixed orientation between the upper and the lower platens 54, 58 is also required. The term fixed orientation means that when the outer flap 64 is subjected to a force that would otherwise urge the outer flap 64 to rotate about the hinge 68 in a direction away from the lower platen 58, such as the forces created during the process of injecting pressurized foam material inside the roof assembly 10, this rotation is prevented by the abutting contact between the cams 122 and the block 124 as previously discussed.

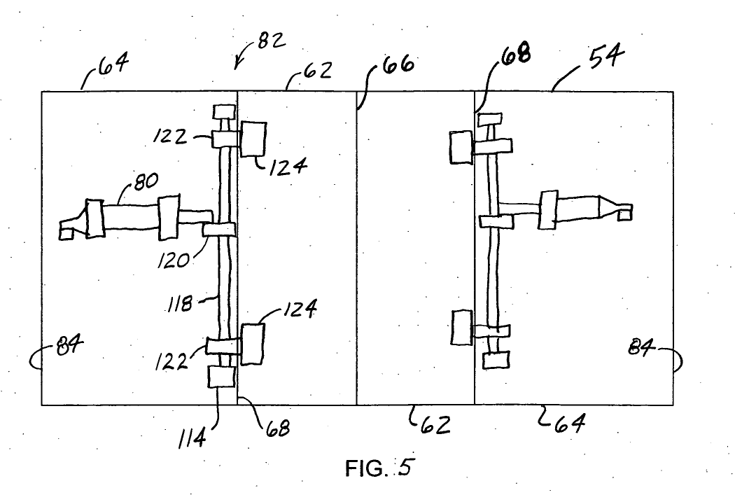

While the abutting contact between the cams 122 and the block 124 prevents the outer flap 64 from rotating about the hinge 68 in one direction (away from the lower platen 58), the conformal contact between the upper conformal surface 56 of the outer flap 64 and the upper surface 30 of the roof assembly 10 prevents the outer flap 64 from rotating about the hinge 68 in the other direction. In other words, if in FIG. 9 the roof assembly 10 were removed, the outer flap 64 would rotate about the hinge 68 until the slack in chain 129 was removed. Preferably, the length of chain 129 is configured to prevent the end 84 of the outer flap 64 from contacting the upper surface 60 of the lower platen 58 when the upper platen 58 is in its raised position. Additionally, since the chains 129 provide vertical support for the outer flaps 64, additional actuators are not required. Alternately, although actuator 80 (FIGS. 2, 5) could be configured to also provide vertical support for the outer flap 64, use of the chains 129 to perform this function permits the size of actuator 80 to be significantly reduced.

Conversely, referring to FIG. 10, if the length of the roof assembly 10 is less than a predetermined length such that the ends 28 of the roof assembly 10 do not extend past the opposed pair of hinges 68 when the roof assembly 10 is positioned in the press 50, the outer flaps 64 do not have to form a conformal contact with the upper surface 30 of the roof assembly 10. In other words, the upper surface 30 of the roof assembly 10 is fully covered by the upper conformal surface 56 of the inner flaps 62, so that the ends 84 of the outer flaps 64 are supported by the chains 129. Further, assuming dimensions “A” and “B” are fixed, reducing the length “L” of the roof assembly 10 increases the angle “C” (FIG. 1 and equation [1] above). If as previously discussed, the inner and outer flaps 62, 64 are maintained in a fixed orientation, as the angle “C” increases, the ends 84 more closely approach the lower surface 60 of the lower platen 58. However, once the angle “C” exceeds a predetermined magnitude, the chains 129 limit the downward travel of the ends 84 of the outer flaps 64 toward the lower platen 58. If, referring back to FIGS. 5, 7 and FIG. 10, each actuator 80 is sufficiently rotated in a direction to likewise rotate the cams 122 of the mechanical linkage 82 out of abutting contact with the block 124, each outer flap 64 may then rotate about hinge 68, preventing the ends 84 of the outer flaps 64 from impinging upon the lower surface 60 of the lower platen 58. Stated another way, in a preferred embodiment, once the angle “C” reaches a certain magnitude for a roof assembly 10 having a surface 20 that is fully covered by the upper conformal surface 56 of the inner flaps 62, the inner and outer flaps 62, 64 are not maintained in a fixed orientation.

Referring to FIGS. 1-4, and 6, heated lower platen 58 provides structural, conformal support to lower surface 32 of roof assembly 10 during the foam injection process. Additionally, heated lower platen 58 provides heat to sufficiently heat a portion of roof assembly 10 to promote bonding between the injected foam material and the heated portion of the roof assembly 10.

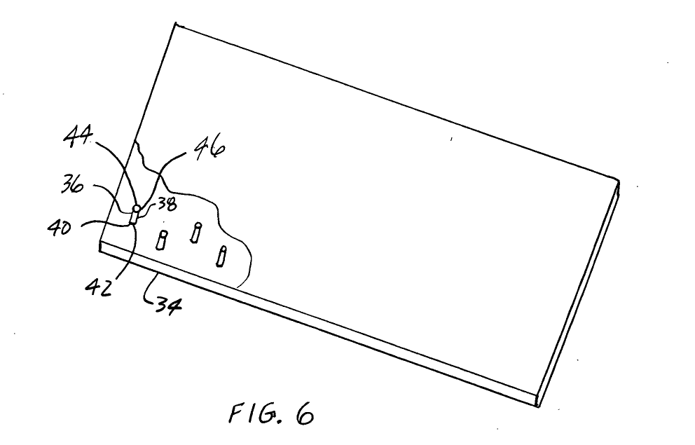

Beneath lower platen 58 is a base plate 34 (FIG. 6) having a plurality of rollers 36 each preferably comprising a standoff 38 having a threaded end 40 that is received by a threaded aperture 42 formed in base plate 34. Roller 36 includes a roller transfer ball 44 rotatably secured in a recess 46 or socket opposite threaded end 40. As shown in FIG. 2, roller transfer balls 44 extend through lower platen 58 for contacting the lower surface 32 of roof assembly 10, permitting the roof assembly 10 to be more easily moved into position in press 50.

Once the roof assembly 10 has been positioned in press 50, actuators 86 that are each hingedly connected to frame 52 of press 50 and to a bar 88 the other end, collectively actuate to raise lower platen 58 to a desired position. Actuators 86 may be hydraulic actuators, receiving pressurized hydraulic fluid from a hydraulic power unit 90 that may be controlled by a tandem solenoid valving arrangement 92, and preferably further having at least one flow divider 94 for controlling the flow of hydraulic fluid to actuators 86. Actuators 86, whether hydraulic, pneumatic or mechanical in operation, are sized to resist movement of lower platen 58 when subjected to forces created during the foam injection process, as well as the weight of the lower platen 58 and the roof assembly 10.

Heated lower platen 58 comprises an interconnected tubular frame 96 preferably including a plurality of rectangular tubes constructed of a material, such as aluminum, having sufficiently high thermal conductivity and structural strength that is also compatible with a fluid system. The joints of tubular frame 96 must be fluid tight as a heated fluid pumped from a heated reservoir 102 by a pump 104 enters an inlet manifold 98 that includes a plurality of lines 99 which are each connected to fittings 103 adjacent a tube member 97 to provide substantially uniform flow of fluid through tubular frame 96. Similarly, fluid that has traveled the length of tube member 97 exits tubular frame 96 through fittings 105 which are connected to an outlet manifold 100 by a plurality of lines 101. This arrangement permits the heated fluid to raise the temperature of tubular frame 96 to a substantially uniform level. A preferred formulation of the circulating fluid is about 70 percent water by volume with the remainder being ethylene glycol. However, any number of fluids, which are compatible with the operating environment, and components, may also be used.

Bonded to the lower surface of tubular frame 96 are a plurality of pairs of angles 110, each pair of angles 110 securing the bar 88 therebetween. The opposed ends of bars 88 that extend outwardly from tubular frame 96 each engage a different actuator 86 for selectively raising and lowering lower platen 58. Lower platen 58 further includes a plate 106 that is bonded to tubular frame 96. Plate 106 includes a plurality of apertures 108 that are both sized and arranged to receive rollers 36 therethrough when heated lower platen 58 is in its lowered position to either receive a roof assembly 10 into the press 50 or to remove the roof assembly 10 from press 50 so that transfer roller balls 44 of rollers 36 contact the lower surface 32 of the roof assembly 10 to more easily move the roof assembly 10.

It is understood by those having skill in the art that instead of a heated fluid circulating through frame 96, it may also be possible to employ heating elements secured to plate 106. Such heating elements may be in the form of electrical resistance, illuminated light, chemical reaction, friction, or otherwise provide conductive, radiative, or convective energy so long as sufficient, substantially uniform elevated temperatures are achieved along tubular frame 96.

When the heated lower platen 58 is raised into position in preparation of the pressurized foam injection process into the roof assembly 10, the lower conformal surface 60 of plate 106 is raised by actuators 86 above that of rollers 36 so that the lower surface 32 of the roof assembly 10 is in conformal contact with the lower conformal surface 60 of plate 106. The heated reservoir 102 includes a heating element (not shown) of sufficient thermal output to heat the fluid circulating through the frame 96 which then heats the plate 106. The plate 106 then sufficiently heats the portion of the roof assembly 10 that is in conformal contact with the plate 106, i.e., the lower surface 32, so that when pressurized foam material is injected inside of the roof assembly 10, the heated portion of the roof assembly 10 promotes bonding with the foam material.

A preferred composition for the foam used in the foam injection process includes trade name FE658V Series Polyol supplied by Foam Enterprises of Houston, Tex. Typically, this composition is a two-part mix, and is applied under pressure, preferably about 400 psi, using 134A refrigerant as a propellant that also cools and agitates the mixed components, which produce an exothermic reaction. The flash point, which is defined in Merriam-Webster's Collegiate Dictionary, Tenth Edition “as the lowest temperature at which vapors above a volatile combustible substance ignite in air when exposed to flame,” is about 400° F. While the temperatures of heated surfaces are maintained well below the flash point, foam material manufacturers also recommend maintaining surface temperatures of at least portions of the vessel that is injected with foam material above about 86° F. to promote more uniform expansion and bonding of the curing foam material to the vessel surface. To achieve at least an 86° F. surface temperature along substantially the entire lower surface 32 of the roof assembly that is in conformal contact with the heated lower platen 58, Applicants have found that for most facility operating conditions, platen 58 must be heated to about 115° F. for about 15 minutes, although if the ambient temperature of the air surrounding the press is slightly less than about 65° F., the platen temperature may need to be about 120° F.

To achieve satisfactory results, the injection process must be closely controlled. This control can be achieved by delivering a known rate of injected material per unit of time for a closely controlled period of time, typically referred to as a “shot count,” after the volume of the inner chamber of the roof assembly has been calculated. The press of the present invention is provided with a viewer or viewing station (not shown), which provides the inner chamber volume of a particular roof assembly based on the part number assigned to the roof assembly. Once this part number information is provided, the shot count is calculated and input into a controller (not shown) prior to initiating the injection operation. Alternately, if a bar code for the roof assembly is used, this portion of the injection process could be automated. The injection process is performed by providing an injection nozzle for dispensing the pressurized foam material that is inserted into the closed chamber of the roof assembly through a specially configured aperture, or several configured apertures, formed in the roof assembly, with each aperture having its own shot count for preferably separately receiving a closely controlled amount of injected material.

Upon completion of the pressurized foam material injections, a curing timer (not shown) is set, to permit sufficient time for the injected insulating foam material to cure. The curing timer is corrected or calibrated, if required, to account for varying ambient conditions surrounding the press that could affect the cure time, including, but not limited to, temperature, humidity, or barometric pressure. Typically, corrections to the curing timer are only required once per day. The curing timer, and other operational aspects of the press are electrically wired to a lighting system 112 (FIG. 2), including an arrangement of differently colored lights, such as red, yellow and green, which is positioned above the press in conspicuous view of factory personnel. That is, both those personnel adjacent the press and those located even significant distances away from the press can view lighting system 112, to alert those personnel of the status of the press and/or a particular operating step of the press. For example, a red light is illuminated when actuators 84 are raising lower platen 54. A yellow light is illuminated when hydraulic pressure is present, such as when the actuators are in an extended position, having previously raised lower platen 54. A flashing green light indicates that the curing timer has been activated and is presently running, while a non-flashing green light indicates that the timer is off, i.e., the foam has substantially cured, and that the roof assembly currently in the press may be removed and replaced by a new roof assembly for receiving injected foam material. Once the foam has cured, either prior to removal of the roof assembly from the press or shortly after the roof assembly has been removed from the press, specially configured plugs are placed in the apertures of the roof assembly to seal the roof assembly from environmental exposure.

In operation, press 50 of the present invention is readied for use by starting pump 104, which also activates the heating element within reservoir 102 for heating fluid that is circulated through tubular frame 96. Once the fluid has been brought up to an operating temperature of about 115° F. to about 120° F., depending upon the ambient temperature of the air surrounding press 50, lighting system 112 may provide an indication, such as by illuminating a green light, to alert an operator to return and begin processing roof assemblies. Lower. platen 58 is lowered and upper platen 54 is manipulated, as required, to permit press 50 to conformally receive a roof assembly 10 therein. When lower platen 58 is in its lowered position, roof assembly 10 is easily manipulated to a desired position by virtue of the rolling contact between lower surface 32 of roof assembly 10 and roller transfer balls 44 of rollers 36 extending from base plate 34 and through plate 106 of lower platen 58. Once roof assembly 10 is positioned and upper platen 54 has been properly positioned, actuators 86 are actuated to raise heated lower platen 58 so that heated plate 106 of lower platen 58 conformally contacts lower surface 32 of roof assembly 10, and lower platen 58 is further raised by actuators 86 until upper conformal surface 56 of upper platen 54 conformally contacts upper surface 30 of roof assembly 10.

To manipulate the upper platen 54 to the proper position, the operator obtains or measures the length “L” of roof assembly 10 as measured along its lower surface 32, and aligns indicator line 136 of graduated angle indicator 130 with the graduated indication 138 that corresponds to the length of roof assembly 10. The operator then actuates gear motor 70, which drives chain 72 into directed movement that meshes with and urges lead screws 74 into rotational movement for rotating inner flaps 62 about hinge 66 of press 50.

If the length of roof assembly 10 is greater than a predetermined length such that the ends 28 of the roof assembly extend past opposed pair of hinges 68, inner and outer flaps 62, 64 form conformal contact with upper surface 30 of roof assembly 10. When inner and outer flaps 62, 64 form conformal contact with upper surface 30 of roof assembly 10, the flaps 62, 64 are maintained in a fixed orientation. This fixed orientation is achieved by the actuation of actuator 80 in a direction which urges arm 120 into rotation about the center axis of bar 118 that is rotatably carried by opposed tabs 114. Cams 122 which are secured to bar 118 are similarly urged into rotation about bar 118 so that cam diameter 126 is rotated into abutting contact with surface 128 of block 124 to prevent outer flap 64 from rotating about hinge 68 in a direction away from lower platen 58, as previously discussed.

However, if the length of roof assembly 10 is less than a predetermined length such that the ends 28 of the roof assembly 10 do not extend past opposed pair of hinges 68, only inner flaps 62 are required to form conformal contact with upper surface 30 of roof assembly 10. Since roof assemblies 10 of shortened length define angles of higher magnitude, sufficiently shortened roof assemblies 10 could permit the ends 84 of outer flaps 64 that are maintained in a fixed orientation with their corresponding inner flaps 62 to impinge upon the lower conformal surface 60 of the lower platen 58. To prevent this impingement, downward travel of each end 84 of each outer flap 64 is limited by respective chain 129, and the fixed orientation between corresponding inner and outer flaps 62, 64 is no longer maintained. In other words, each inner flap 62 must rotate with respect to its corresponding outer flap 64.

To achieve the rotation of each outer flap 64 with respect to its corresponding inner flap 62, actuator 80 is actuated in a direction that similarly urges arm 120 into rotation about the center axis of bar 118 that is rotatably carried by opposed tabs 114. Cams 122 which are secured to bar 118 are similarly urged into rotation about bar 118 so that cam lobe 126 is rotated out of abutting contact with surface 128 of block 124.

Once the upper plate 54 has been properly positioned, including permitting angular movement between inner and outer flaps 62, 64, if required, as previously discussed, upper conformal surface 56 and upper surface 30 are brought into conformal but nondeforming contact by actuators 86. In this position, both the upper surface 30 of roof assembly 10 is in conformal, nondeforming contact with the upper conformal surface 56 of upper platen 54, and the lower surface 32 of roof assembly 10 is in conformal, nondeforming contact with the lower conformal surface 60 of lower platen 58. Once such conformal contact is achieved, the position of the platens 54, 58 with respect to the corresponding surfaces of the roof assembly 10 remains substantially fixed for a sufficient period of time, such as about 15 minutes, to permit heated lower platen 58 to raise the temperature of lower surface 32 of roof assembly 10 to a temperature above a predetermined temperature, such as about 86° F.

At any time prior to performing the injection operation of pressurized foam material, the curing timer is calibrated or corrected to account for ambient conditions surrounding the press. Once the viewer or viewing station identifies the part number of roof assembly 10, from which the volume of the roof assembly 10 is then calculated, the volume is then input into the controller to calculate the duration of each shot count, although this information can be automated, if desired.

Upon the calculation of the desired shot counts, the injection process is performed by inserting the injection nozzle inside the roof assembly through the specially configured apertures 18, and injecting a pressurized mixture of foam material using 134A refrigerant as a propellant. Once the injection process is completed, the curing timer is set, and allowed to run for a predetermined period of time, such as about 15 minutes, although the duration could deviate from this amount, depending upon the ambient conditions of the air surrounding the press and the size of the roof assembly. Lighting system 112, which illuminates a yellow light from the time hydraulic pressure is applied to actuators 86, also illuminates a flashing green light while the curing timer is running, and switches to a constant or non-flashing green light when the predetermined set time for the curing timer has elapsed. The non-flashing green light indicates that the press is ready to process another roof assembly, and the process may be repeated.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A press comprising:
an upper platen and a heated lower platen that are selectably movable toward and away from each other for conformally but nondeformingly receiving a vessel therebetween so that vessel surfaces in conformal contact with the upper platen and the lower platen remain substantially undeformed while the vessel is filled with a pressurized material; and
wherein a portion of the vessel is heated to at least a predetermined temperature by the heated lower platen.

2. The press of claim 1, wherein the vessel is a roof assembly.

3. The press of claim 2, wherein surfaces of the roof assembly in conformal contact with the upper platen and the lower platen are non-parallel.

4. The press of claim 1, wherein the vessel is an angled roof assembly.

5. The press of claim 4, wherein the angled roof assembly is for use with an air handling unit.

6. The press of claim 1, wherein the heated lower platen is heated by heated fluid.

7. The press of claim 1, wherein the heated lower platen is heated by heating elements.

8. The press of claim 1, wherein the pressurized material is an injected foam material.

9. The press of claim 8, wherein a portion of the vessel is sufficiently heated by the heated lower platen to promote substantially uniform expansion and curing of the injected foam within the vessel.

10. The press of claim 8, wherein a portion of the vessel is sufficiently heated by the heated lower platen to promote bonding between the injected foam and the heated portion of the vessel.

11. The press of claim 1, wherein the temperature of the heated lower platen is less than the flash point temperature of the injected material.

12. The press of claim 1, wherein the upper platen comprises at least two movable portions.

13. The press of claim 12, wherein the at least two movable portions are hingedly connected.

14. The press of claim 13, wherein one of the at least two movable portions may be rotated independently of the remaining portions of the at least two movable portions.

15. The press of claim 13, wherein a graduated indicator having at least one graduated indication corresponding to a feature of the vessel is used to position the at least two movable portions.

16. The press of claim 15, wherein the feature of the vessel is the length of the vessel.

17. The press of claim 1, further comprising a plurality of rollers extending through the lower platen for receiving the vessel between the upper platen and the lower platen.

18. The press of claim 13, further comprising at least one device associated with a hinged connection to selectively prevent rotational movement in a predetermined direction of one of the at least two movable portions.

19. The press of claim 18, wherein the at least one device is a cam.

20. The press of claim 19, wherein the cam is selectively actuated by at least one actuator.

21. A method of filling a vessel with a pressurized material, the steps comprising:
providing a press having an upper platen and a heated lower platen that are selectably movable toward and away from each other;
securing a vessel conformally but nondeformingly between the upper platen and the heated lower platen so that a portion of the vessel is heated to at least a predetermined temperature by the heated lower platen; and
filling substantially the vessel with a pressurized material so that vessel surfaces in conformal contact with the upper platen and the lower platen remain substantially undeformed while the vessel is substantially filled with a pressurized material.

22. The method of claim 21, wherein the vessel is an angled roof assembly.

23. The method of claim 22, wherein the angled roof assembly is for use with an air handling unit.

24. The method of claim 21, wherein the step of filling substantially the vessel includes filling substantially the vessel with an injected foam.

25. The method of claim 21, wherein the step of securing the vessel so that a portion of the vessel is heated to at least a predetermined temperature by the heated lower platen includes the heated portion of the vessel promoting substantially uniform expansion and curing of the pressurized material filling substantially the vessel.

26. The method of claim 25, wherein the pressurized material is an injected foam material.

27. The method of claim 21, wherein the step of securing the vessel so that a portion of the vessel is heated to at least a predetermined temperature by the heated lower platen includes the heated portion of the vessel promoting bonding between the pressurized material and the heated portion of the vessel.

28. The method of claim 27, wherein the pressurized material is an injected foam.

29. The method of claim 27, wherein at least a predetermined temperature is above about 115° F.
